(19) United States
(12) Patent Application Publication
(10) Pub. No.: US 2022/0379769 A1
(43) Pub. Date: Dec. 1, 2022

(54) Bidirectional AC V2G for Multifamily/Workplace Electric Vehicle Charging

(71) Applicant: NetZero V2G Technologies LLC, Fort Washington, PA (US)

(72) Inventor: Paul Harriman Kydd, Lawrenceville, NJ (US)

(21) Appl. No.: 17/330,662

(22) Filed: May 26, 2021

(51) Int. Cl. B60L 55/00; B60L 53/20; B60L 53/66

(52) U.S. Cl. CPC B60L 55/00; B60L 53/20; B60L 53/665

(57) ABSTRACT

This invention is based on the availability of Electric Vehicles with onboard inverters and receptacles to supply significant amounts of AC power from the main propulsion batteries of the vehicles. It embodies a system comprising an apparatus and methods for bidirectionally connecting one or more electric vehicles at a workplace or multifamily residence to one or more distribution panels supplying critical loads and one or more panels supplying interruptible loads such that the vehicle(s) can supply back up power to critical loads during a grid outage. The bidirectional connection also enables V2G operation to enable energy arbitrage, demand response, and ancillary services to the grid.

### CROSS-REFERENCES TO RELATED APPLICATIONS

This application is related to U.S. patent application “Vehicle-Solar-Grid Integration” Ser. No. 14/101,423 filed Dec. 10, 2013, now issued as U.S. Pat. No. 9,566,867, Feb. 14, 2017, by the present inventor, and Provisional Patent Applications “Bidirectional Power Electronic Interface” No. 61/889,067, filed Oct. 10, 2013, “Bidirectional Power Electronic Interface with Sustaining Power” 61/921,583, filed Dec. 30, 2013, “Vehicle-Solar-Grid Integration with Supplementary Battery” 62/050,819, filed Sep. 16, 2014, “Low-Cost EVPV for Vehicle-Solar-Grid Integration” 62/297,462, filed Feb. 19, 2016, “Minimum Cost EVPV for Vehicle-Solar-Grid Integration” 62/299,756, filed Feb. 25, 2016, later filed as non provisional patent application Ser. No. 15/441,484, Feb. 24, 2017, now issued as U.S. Pat. No. 10,439,428, Oct. 8, 2019, and a companion filing “Method of Using Minimum Cost EVPV for Vehicle-Solar-Grid Integration” Ser. No. 16/562,565, Sep. 3, 2019, “Vehicle-Solar-Grid Integration for Back up Power” 62/465,424 filed Mar. 1, 2017 now filed as non provisional patent application Ser. No. 16/044,683, Application “Non Grid-Tied Vehicle-Solar Uninterruptable Power System” 62/544,041, filed Aug. 11, 2017, now filed as patent application Ser. No. 16/055,035, and issued as U.S. Pat. No. 10,693,315 Jun. 23, 2020, and “Demand Charge Management by Electric Vehicles”, 62/721,216, filed Aug. 22, 2018, and now filed as non provisional patent application Ser. No. 16/563,108, “Minimum Cost Demand Charge Management by Electric Vehicles”, “Electric Vehicle Service Equipment Adapter Module to Control Added Loads”, Ser. No. 16/580,663 Sep. 24, 2019, by the present inventor, Provisional Patent Application 62/978,381, “Optimum Utilization of Electric Circuit Capacity by Adding Electric Vehicle Charging”, filed Feb. 19, 2020, Provisional Patent Application 63/116,516 “Solar-Energized Workplace Electric Vehicle Charging” by the present inventor, Nov. 20, 2020, and “Multiple Load Micro-Grid Implementation of Vehicle-Solar-Grid Integration” 62/320,701, filed Apr. 11, 2016, by the present inventor and Brian R. Hamilton of Cranbury, N.J., and Chris A. Martin of Media, Pa.

### FEDERALLY SPONSORED RESEARCH

None

### CITED LITERATURE

1. Ford Motor company promotional material for Ford F-150 Lightning pickup truck, May 23, 2021
2. https://countryeconomy.com/business/car-registrations/usa

### PATENT LITERATURE

1. Provisional Patent Application 62/978,381, “Optimum Utilization of Electric Circuit Capacity by Adding Electric Vehicle Charging”, P. H. Kydd, now filed as U.S. Utility patent application Ser. No. 17/248,576, Jan. 1, 2021.
2. Provisional Patent Application 63/116,516 “Solar-Energized Workplace Electric Vehicle Charging” P. H. Kydd, Nov. 20, 2020
3. Patent Application 2013/0338527, “Apparatus for Bidirectional Electric Power Supply between Electric Vehicle and Smart Grid and Method of Bidirectionally Supplying Electric Power Employing the Same” Kang J-J, Jun. 10, 2013

### FIELD OF THE INVENTION

The present disclosure describes an apparatus and method for providing true Bidirectional Vehicle to Grid (V2G) interconnection based on electric vehicles which have on board inverters able to provide AC electric power via receptacles on the vehicle. A new generation of electrified working vehicles typified by the Ford Hybrid F-150 pickup truck and the fully battery powered F-150 Lightning pickup truck to be introduced in spring, 2022, offer this capability, primarily to support electric tool use in the field, but also to provide backup power to the home in case of a grid outage¹. ¹ Provisional Patent Application 63/116,516 “Solar-Energized Workplace Electric Vehicle Charging” P. H. Kydd, Nov. 20, 2020

Most of these vehicles will be recharged individually at home. Ford and other companies are making provision for automatic transfer switches to allow the vehicle to power the home in an outage. Additional “smart charging” features are planned to restrict charging to off peak hours to minimize impact on the grid. This invention is specifically directed at aggregations of such vehicles, which can cooperate to provide a more extensive suite of services to the grid. An example would be fleets of commercial vehicles all parked in the same location overnight for recharging. Other examples are multifamily residential locations with tens or hundreds of assigned parking spaces for recharging overnight, and workplace charging, in which similar numbers of vehicles are recharged during the daylight hours.

### BACKGROUND OF THE INVENTION

The availability of this bidirectional AC technology in quantity makes available potentially enormous battery storage capacity to support the grid in supplying the very large increase in electric demand occasioned by the vehicles. Currently US commercial vehicle sales are at an annual rate of 12,500,000 while passenger cars trail at 3,500,000². If all the commercial vehicle sales convert to electric energy and offer AC power take offs, more than 80 percent of the miles driven for personal transportation will be electric powered, increasing total electric energy demand by roughly 20%. Offsetting this an additional 20 billion kWh of electric energy storage will become available, enough to keep the entire US grid running for a day or more. ² Description of Open Charge Point Protocol (OCPP) at openchargealliance.org

When grouped in large numbers the Bidirectional EVs can provide a complete suite of services to the grid described collectively as Vehicle to Grid (V2G) technology.

These services include as major categories:
Back up power for resiliency in outages
Energy arbitrage
Demand response to capacity “events”
Regulation services to maintain voltage and frequency

Back up power is already a goal of the AC outlet-equipped electric vehicles. Per IEEE standard 1547 it is essential to ensure that the emergency supply cannot feed back into the grid during the outage to prevent hazard to linemen working to fix the problem. This requires switching, preferably automatic, to connect the electric load, or at least the critical part of it, to the truck and disconnect it from the grid. Provision for segregation of the load in this way may be more cost-justified in a large commercial/industrial installation, particularly one where continuity of energy supply is critical.

Energy arbitrage comprises “buy low and use” as well as the familiar “buy low, sell high”. It is enabled in this case by the ability of electric vehicles to be charged at any time as long as they obtain enough total energy to perform the mission. The obvious way to take advantage of this is to postpone charging till the early morning hours when energy is typically abundant and cheap.

Capacity payments to loads that can provably shut down in response to excessive demands for power elsewhere on the grid are valued currently at approximately $60 per “NegaWatt” or per kW of load that can be shed for up to 12 hours on demand by PJM, the MidAtlantic Regional Transmission Operator (RTO). It is necessary to provide utility grade meters and prove that they constitute an actual load that can be reduced by the stated amount at any time. It also requires remote control of all of the EVSEs and data to prove that it happened. With a large number of EVs at a single location controlled by a single entity it is much easier to meet all of these requirements and participate in this market. A location with 50 EVs charging at 10 kW is a load of more than 500 kW, well above the minimum 100 kW increment for remuneration for grid services. The metering and demonstration are clearly easier for a single entity providing and controlling the charging of the vehicles. In the event of an “event” the omission of a single charging session should not be a major problem for these very long range vehicles which may only be accumulating 20% of their capacity in a single day's recharge.

Regulation service is the most attractive opportunity for serving the grid and earning revenue by providing storage. The RTO needs to balance supply and demand on the grid to maintain both voltage and frequency stability. Battery storage is ideal for this purpose because it can respond instantaneously and powerfully to requests for more or less electric energy. A special premium tariff for this service called Reg. D. has been established by PJM. These requests are transmitted to curtailment suppliers at two-second intervals, and generators and controlled loads bid in the day-ahead market to provide service. Those whose bids are accepted are monitored and recompensed based on the accuracy with which they respond. The current rate is approximately $0.02 per kWh bid and accepted. Bidirectional V2G is a major step up in revenue compared to simply modulating the charging load (or any other load like water heating that is flexible as to schedule), which may be called V1G. An EV charging 20 kWh per day can provide half that amount as V1G regulation service and earn up to $0.20 per day. An EV with bidirectional capability of 10 kW in and out, like the Ford Lightning can earn $0.20 per hour for every V2G hour it is plugged in, or as much as $4.80 per day.

EV recharging presents an opportunity for employers and landlords to offer recharging facilities to their employees and tenants, either as an amenity or as a profit-making addition to their facilities. This addition does not come for free however. It is likely to involve additional investment in electric power supply to support the EV charging facilities and will certainly increase the electric energy bill of the facility.

It is also likely to increase the demand charge associated with the additional demand for energy. Commercial and Industrial electric suppliers bill their clients for the energy consumed in kilowatt-hours (kWh) each month, and for the peak demand in kilowatts (kW). The latter represents the necessary return on the investment in transmission and distribution equipment, which has to be sized to deliver the peak load. The demand charge each month typically amounts to roughly the same as the cost of the energy transmitted, and serves as a powerful incentive to present a constant load and avoid peaks in demand.

With an aggregation of EVs it is possible to level the charging load to minimize the impact on the demand charge. Reference 2 [0004]³ describes a method of Dynamic Demand Charge Management in which the charging can be controlled to occur during low points in the major local load, thereby leveling the total load and minimizing demand charges. ³ Surface Vehicle Recommended Practice, J-1772 SAE Electric Vehicle

There is an opportunity to increase the efficiency with which electric energy is utilized still further by grouping EVSEs together while limiting the amount of power in kW that the group can draw. Grouping is a feature that several EVSE network suppliers offer. It operates by networking a specified group of EVSEs over the Internet so that cloud-resident software can limit the amount of power drawn by the group to a specified amount, and distribute this amount evenly to the EVSEs in the group.

### BRIEF SUMMARY OF THE INVENTION

This invention consists of an apparatus capable of remotely controlling the charging rate of an EV and remotely controlling the output of the AC power take off from an on board inverter to accomplish certain objectives which comprise the methods of the invention.

The apparatus comprises a remotely controllable Electric Vehicle Service Equipment (EVSE, Charger), and a remotely controllable switch for taking AC electric power from the vehicle, both EVSE and switch are continuously connected to the vehicle by Electric cords when it is parked. The switch provides AC power to a set of critical loads. The critical loads and the vehicle can be isolated by an automatic transfer switch during power outages. Normally the critical loads are supplied by the grid, which also supplies a main load panel. The EVSE is supplied by the main load panel.

The objectives of this arrangement are to provide backup power during grid outages and opportunities for energy cost minimization during normal operation. Bidirectional connection to the grid also provides opportunities for capacity payments and for earnings from ancillary services to the grid.

The EVSE and switch are controlled to accomplish the objectives of this invention remotely over the Internet using remote control protocols such as OCPP². These allow individual EVSEs to be turned on and off, and their output can be modulated for proportional control. To accomplish ancillary services the EVSE outputs and vehicle outputs will be controlled from second to second in response to demands from the grid RTO. ² Description of Open Charge Point Protocol (OCPP) at openchargealliance.org

### BRIEF DESCRIPTION OF THE DRAWINGS

FIG. 1 is a schematic diagram showing the apparatus of this invention applied to a building with panels for distribution of electric energy to critical loads and regular loads separated by an automatic transfer switch. The electric vehicle is charged by an EVSE powered by the regular load panel, and it can power the critical load panel from its on board inverter and AC receptacle during outages.

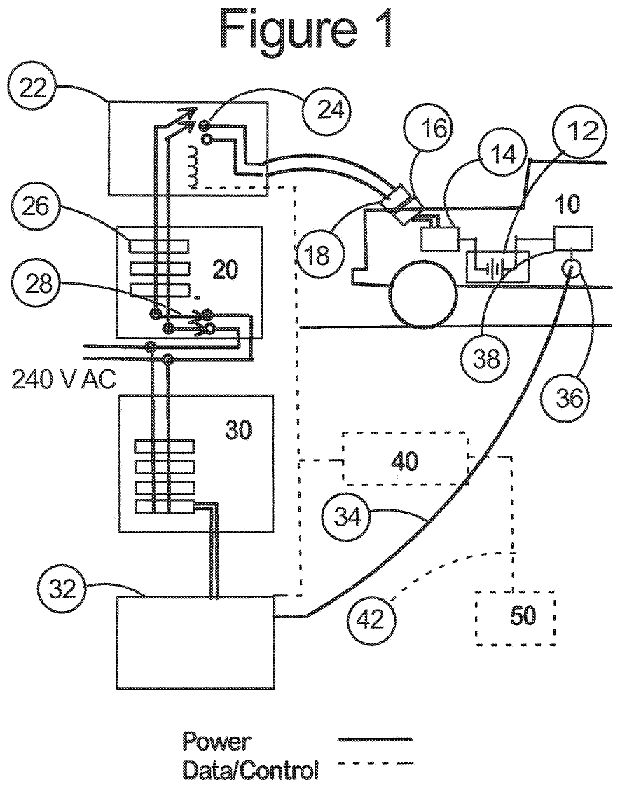

### DETAILED DESCRIPTION OF THE INVENTION: THE PREFERRED EMBODIMENT

Electric vehicle 10 is powered by storage battery 12, which may have a capacity of a much as 100 kWh in long-range vehicles. Vehicle 10 also has an on board inverter 14 to provide AC power through receptacle 16 to operate power tools and the like. When parked for recharging receptacle 16 is connected by plug 18 to a controllable connector 22 to a critical loads panel 20. Connection 24 is shown as an electro mechanical relay, but is more properly a semiconductor relay that can be controlled to provide a proportional amount of power to the critical loads panel and on to the grid. Slots 26 are circuit breakers to individual loads which need to continue operating in an emergency such as emergency lighting, elevators and minimal ventilation. A number of vehicles 10 may be connected to one critical loads panel to ensure adequate endurance. Switch 28 is an automatic transfer switch to isolate the critical loads panel and its vehicle power supply in an outage.

Emergency load panel 20 and regular load panel 30 are powered from the grid, typically at 240 V or 208 V. One of the regular loads is the recharging of vehicle 10 via EVSE 32 and flexible cable and plug 34 to vehicle receptacle 36. The design and operating details of the EVSE and plug are typically specified in SAE Standard J-1772³. They provide AC power to on board charger 38, which rectifies it to DC power to charge battery 12. EVSE 32 needs to be remotely controllable, preferably to provide a proportional amount of power to the vehicle. Again a number of EVs can be charged from a single panel. ³ SAE Surface Vehicle Recommended Practice, J-1772 SAE Electric Vehicle Conductive Charge Coupler, revised October, 2012.

EVSE 32 and connector 22 are remotely controlled by aggregator software 40 which may be located physically in a local microcontroller or remotely in the cloud. There are networks 50 designed to enable control of large numbers of EVSEs remotely over the Internet, either via a local WiFi connection or by cellular phone. One such is the JuiceNet maintained by ENEL-X Emobility.

When not in use vehicle 10 is plugged in to both to EVSE 32 and to connector 22. In this condition it can provide frequency regulation service. Typically grid operators need to give or get increments of electric power from second to second to maintain the grid frequency at exactly 60 Hz. There is a well-established market for providing this service in increments of 100 kW and getting paid for it through Curtailment Service Providers (CSPs). The operators qualify both generators and controllable loads, which can provide regulation services. The qualified entities then bid to provide services in the day-ahead market through the CSPs. Accepted bidders receive commands to increase or reduce availability of energy on the grid and are remunerated based on their performance. An aggregation of EVSEs can be controlled remotely to provide this service. This is Vehicle-to-Grid, or V2G operation.

To confirm that the agreed regulation service has been performed, it is necessary that the communication loop be completed from the individuals EVSEs back through the local controllers or the EVSE network to the aggregators, and on to the CSP and to the ISO/RTO for confirmation.

Capacity payments depend on the recipient's ability to demonstrate to the RTO that they can indeed increase output or reduce demand by the specified amount for a specified time, typically 12 hours in the summer, and do this reliably whenever required. For a managed load, this requires demonstrating that the load is real with reliable metering, and that it can be interrupted reliably. Normal electric vehicle charging does not fit this profile well because the charging load is distributed geographically and time wise, making it difficult to guarantee a stated reduction at a arbitrary time. With bidirectional capability it is much easier to comply with these requirements because the plugged in vehicles can either reduce charging rate if they are charging or deliver the same amount of power if they are full. In this way it is possible to guarantee compliance, especially if the vehicles are concentrated in a single location such as a multifamily residence.

The same capability makes it possible to perform actual energy arbitrage by charging vehicles as fast as possible when energy is cheap and returning it to the grid when it is expensive. The utilities frown on this practice and regulate to suppress it. A more acceptable practice is to control charging to occur at periods of low demand such as midnight to 6 AM. By doing so and acting as an energy broker to buy energy at that time, the aggregator can profitably resell energy to the customer or to a third party Load Serving Entity at a lower price than their average billing price.

Back up power is provided by this invention automatically. The EV is expected to be plugged in at all times when not in use, and to be charging when energy is available and reasonable in price. It will therefore have a considerable amount of energy on board except immediately after a several hundred-mile trip. If the power goes out, the automatic transfer switch automatically isolates the critical loads from the grid and leaves them connected to the vehicle with whatever energy it has on board. Typically a half charge will approach 50 kWh and with a number of vehicles connected this number will be more reliable. The typical outage is only minutes in duration, which will not be noticed. The more severe outages are those that last for days, and in those cases a bidirectional vehicle could actually go to a site with power, load up and bring it back to a site without power, providing irreplaceable and essential electric energy.

### RELEVANT PREVIOUS LITERATURE

V2G is not a new concept and there are many patents and papers dealing with it since approximately 2000. One such⁴ is representative. It discloses an onboard inverter/charger to provide bidirectional power flow to/from a vehicle. There are stationary inverter chargers that perform the same function, such as those that were produced by Princeton Power Systems. The unique feature of this invention is to use the very recent availability of onboard inverters with high power capability to make available a simple and inexpensive control apparatus and method using the functions and equipment already provided by the vehicle manufacturer to achieve the same end at less cost. ⁴ Patent Application 2013/0338527, “Apparatus for Bidirectional Electric Power Supply between Electric Vehicle and Smart Grid and Method of Bidirectionaly Supplying Electric Power Employing the Same” Kang J-J, Jun. 10, 2013

While the drawing and descriptions in this application are intended to be comprehensive, it will be understood by those skilled in the art that there are similar means to achieve the same ends, which fall within the claimed scope of this invention.

I claim:

1. An apparatus comprising;
A plug, a cord and a remotely controllable connector to take electric energy from an electric vehicle, said electric vehicle being equipped to supply AC power via an onboard inverter from a main propulsion battery of the vehicle,
A switch in the connector enabling the vehicle to feed remotely controllable amounts of electric power to a distribution panel to supply critical loads, which require back up power during grid outages,
Said critical load panel being equipped with an automatic transfer switch to isolate it from an electric energy supply grid during grid outages,
A remotely controllable Electric Vehicle Service Equipment supplied with electric power from a separate distribution panel providing AC electric energy to recharge the electric vehicle via the onboard charger of the vehicle,
Control software to control said connector and said EVSE to accomplish various objectives,
Communications and control equipment to enable said software to function.

2. The apparatus of claim 1 in which the switch in the connector is replaced by a semiconductor control device providing for a continuous and proportional flow of energy from the vehicle.

3. The apparatus of claim 1 in which a number of electric vehicles are connected to a single set of critical load and distribution panels.

4. The apparatus of claim 1 in which the control functions are performed remotely by an aggregator of several such systems.

5. The apparatus of claim 1 in which the EVSE provides electric energy to the vehicle through an SAE J-1772 standard cord and plug.

6. The method of installing and operating the apparatus of claim 1 in which when electric vehicles are plugged into the EVSEs they receive a minimum rate of charge that will maintain the communication between the vehicle and the EVSE, which can be increased to provide additional range for the EV or offset by withdrawals through the connector.

7. The method of installing and operating the apparatus of claim 1 in which electric energy can be withdrawn from the grid and used to recharge electric vehicles at times when it is available and inexpensive and can be resold to suppliers or users of electric energy at a price below the average price of electric energy.

8. The method of installing and operating the apparatus of claim 1 in which electric energy demand on the grid can be reliably reduced and capacity payments earned by a combination of reducing the rate of EV charging and/or returning energy to the grid.

9. The method of installing and operating the apparatus of claim 1 in which the rate of EV battery charge and discharge is modulated in response to requests from the grid ISO/RTO to provide frequency regulation service and revenue.
